(19) United States
(12) Patent Application Publication
(10) Pub. No.: US 2012/0278791 A1
(43) Pub. Date: Nov. 1, 2012

(54) UTILIZING TEMPORAL ASSERTIONS IN A DEBUGGER

(76) Inventor: Daniel Geist, Haifa (IL)

(21) Appl. No.: 13/518,141

(22) PCT Filed: Jan. 2, 2011
(86) PCT No.: PCT/IL11/00001

§ 371 Date: Jun. 21, 2012

Related U.S. Application Data
(60) Provisional application No. 61/293,213, filed on Jan. 8, 2010.

(51) Int. Cl. G06F 9/44

(52) U.S. Cl. 717/125

(57) ABSTRACT

A temporal assertion of a computer program may be defined based on a temporal property. A checker may be generated to monitor the temporal assertion and indicate upon a violation thereof. The checker may be operatively coupled to a debugging module operative to execute the computer program in a debugging session. The execution may be paused in response to an indication from the checker of a violation of the temporal assertion, while continuing the debugging session. A user may then review the state of the computer program to assess what caused the assertion to fail and whether such a violation indicates the presence of a bug or not.

### CROSS-REFERENCE TO RELATED APPLICATIONS

This application claims the benefit of U.S. Provisional Application No. 61/293,213 filed Jan. 8, 2010, which is hereby incorporated by reference.

### TECHNICAL FIELD

The present disclosure relates to debugging of a program for a computerized device, in general, and to definition of stop-points during a debugging session, in particular.

### BACKGROUND

Computerized devices are an important part of the modern life. They control almost every aspect of our life—from writing documents to controlling traffic lights. However, computerized devices are bug-prone, and thus require a verification phase in which the bugs should be discovered and corrected. The verification phase is considered one of the most difficult tasks in developing a computerized device. Many developers of computerized devices invest a significant portion of the development cycle to discover erroneous behaviors of the computer program. One of the most time consuming tasks during the verification phase is code debugging. Debugging is the task of finding the root cause of an error. The task of debugging may take a long time when the computer program is complex and/or when the amount of data that the computer program retains is large. When dealing with parallel processing, debugging is considered even harder as additional non-deterministic behavior is introduced to the computer program in the form of scheduling of the various concurrent entities (e.g., threads, processes, or the like).

Assertions are commonly used to provide for a better verification phase. By placing an assertion, the developer is insured that if an execution that violates the predicate of the assertion is executed, an indication will be provided. The predicate may be any condition on values of variables of the computer program that is computable by the computer program itself. For example, the condition may be i>j, func1( )=0, or the like. When an assertion fails, the execution of the computer program is terminated, and an error message may be printed to inform the developer on the violation of the assertion.

A temporal assertion is a statement in temporal logic defining a temporal relationship between variables and/or predicates. The temporal assertion may be, for example, “if a=1 then next b=1”, “if a=1 then eventually a=0”, or the like.

### BRIEF SUMMARY

One exemplary embodiment of the disclosed subject matter is a computer-implemented method for debugging a program, the method performed by a computerized device, wherein the program is defined by a general-purpose programming language, the method comprising: obtaining a temporal assertion, wherein the temporal assertion defines a temporal relationship, using temporal operators, between variables defined by the program; generating a checker based on the temporal assertion, wherein the checker is a program product operative to monitor values of the variables and provide an indication upon violation of the temporal assertion; executing the program in an interactive debugging session, wherein during execution of the program the checker monitors the program at predetermined occurrences defined by a temporal semantics; and wherein in response to the indication from the checker, pausing the execution of the program while continuing the interactive debugging session.

Another exemplary embodiment of the disclosed subject matter is a computerized apparatus for debugging a program, the computerized apparatus having a processor and a storage device, wherein the program is defined by a general-purpose programming language; the computerized apparatus comprising: a temporal assertion obtainer operative to obtain a temporal assertion, wherein the temporal assertion defines a temporal relationship, using temporal operators, between values of variables defined by the program; a checker generator operative to generate a checker based on the temporal assertion, wherein the checker is a program product operative to monitor values of the variables and provide an indication upon violation of the temporal assertion; a debugging module operative to execute the program in an interactive debugging session; the debugging module is operative to enable the checker to monitor the execution of the program at predetermined occurrences defined by a temporal semantic; and wherein said debugging module is responsive to the indication of the checker, wherein said debugging module is operative to pause the execution of the program while continuing the interactive debugging session in response to the indication.

Yet another exemplary embodiment of the disclosed subject matter is a program product for debugging a program, the program product embedded on a non-transitory computer readable medium; wherein the program is defined by a general-purpose programming language; the program product comprising: a first program instruction for generating a checker associated with a temporal assertion, wherein the temporal assertion defines a temporal relationship, using temporal operators, between values of variables defined by the program, wherein the checker is a computer program product operative to determine, in response to receiving updates of values of variables defined by the computer program, whether the temporal assertion is violated, wherein the checker is operative to provide an indication upon violation of the temporal assertion; a second program instruction for interfacing with a general-purpose debugger, wherein the general-purpose debugger is configured to load the computer program and the first program instruction to a computer memory, wherein the second program instruction is operative to invoke the first program instruction, to cause the general purpose debugger to set stop-points at predetermined occurrences based on a temporal semantic, wherein the stop-points are configured to update the checker generated by the first program instruction.

Yet another exemplary embodiment of the disclosed subject matter is a program product comprising: a non-transitory computer readable medium; a first program instruction for obtaining a temporal assertion, wherein the temporal assertion defines a temporal relationship, using temporal operators, between variables defined by a program, wherein the program is defined by a general-purpose programming language; a second program instruction for generating a checker based on the temporal assertion, wherein the checker is a program product operative to monitor values of the variables and provide an indication upon violation of the temporal assertion; a third program instruction for executing the program in an interactive debugging session, wherein during execution of the program the checker monitors the program at predetermined occurrences defined by a temporal semantics; a fourth program instruction responsive to the indication from the checker, said fourth program instruction operative to pause the execution of the program while continuing the interactive debugging session; and wherein said first, second, third and fourth program instructions are stored on said non-transitory computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A and 1B show computerized environments in which the disclosed subject matter is used, in accordance with some exemplary embodiments of the subject matter;

FIG. 2 shows a block diagram of an apparatus, in accordance with some exemplary embodiments of the disclosed subject matter;

FIGS. 3A and 3B show flowchart diagrams of methods, in accordance with some exemplary embodiments of the disclosed subject matter; and

FIG. 4 shows a block diagram of a computer program product, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to assist a developer in debugging a Computer Program (CP). Another technical problem is to enable extension of the functionality of a general-purpose debugger, to enable debugging assistance, in accordance with the disclosed subject matter.

One technical solution is to utilize a temporal assertion checker. The temporal assertion checker may be configured to check whether a temporal assertion is violated. The temporal assertion may take into account values of variables during the execution of the CP. The temporal assertion checker may interface with a debugger executing the CP. The checker may monitor, either actively or passively, values of the variables of the CP. The debugger may be responsive to an indication from the checker that the CP violated the temporal assertion. Another technical solution is to set stop-points, in accordance with a user-configurable temporal semantic. The stop-points may be conditioned, so as to induce evaluation of the condition at predetermined occurrences, according to the temporal semantic. By evaluating the condition, the checker may be updated with values of the variables of the CP. In addition, evaluation of the condition enables to pause the debugging session in response to an indication from the checker. Yet another technical solution is to provide for a library module to be linked with the CP and loaded together by the debugger. The debugger may cause generation of the checker by invoking functions of the library module. The debugger may cause the generation in response to one or more commands inputted by a user. A debugger command may be defined to enable the user to use a more user-friendly interface. Yet another technical solution is to utilize breakpoints, that may or may not be conditioned, to adhere to a location semantic scheme. Yet another technical solution is to utilize watchpoints, that may or may not be conditioned, to adhere to a change semantics update scheme. In some exemplary embodiments, the debugger may not support watchpoints/breakpoints conditioned on the value of a function. In such exemplary embodiments, a yet another technical solution may include pre-processing an annotated CP to include code useful for the disclosed subject matter. The code may facilitate setting a breakpoint conditioned on a flag variable instead of a breakpoint/watchpoint conditioned on a value of a function.

One technical effect of utilizing the disclosed subject matter is to enable an easier debugging of the CP. During debugging, once a temporal assertion is violated, the execution pauses and the developer may review the values of the variables of the CP and debug the CP from that point on. Another technical effect is enabling extension of general-purpose debuggers in a simple manner, such that a developer may use his preferable debugger while still taking advantage of the disclosed subject matter. Yet another technical effect is to enable the developer to define a user-configurable temporal semantic. The temporal states of the temporal semantic may be defined, for example, as beginning at predetermined locations in the CP (using location semantic update scheme), or in response to access/modifications of predetermined variables (using change semantic update scheme).

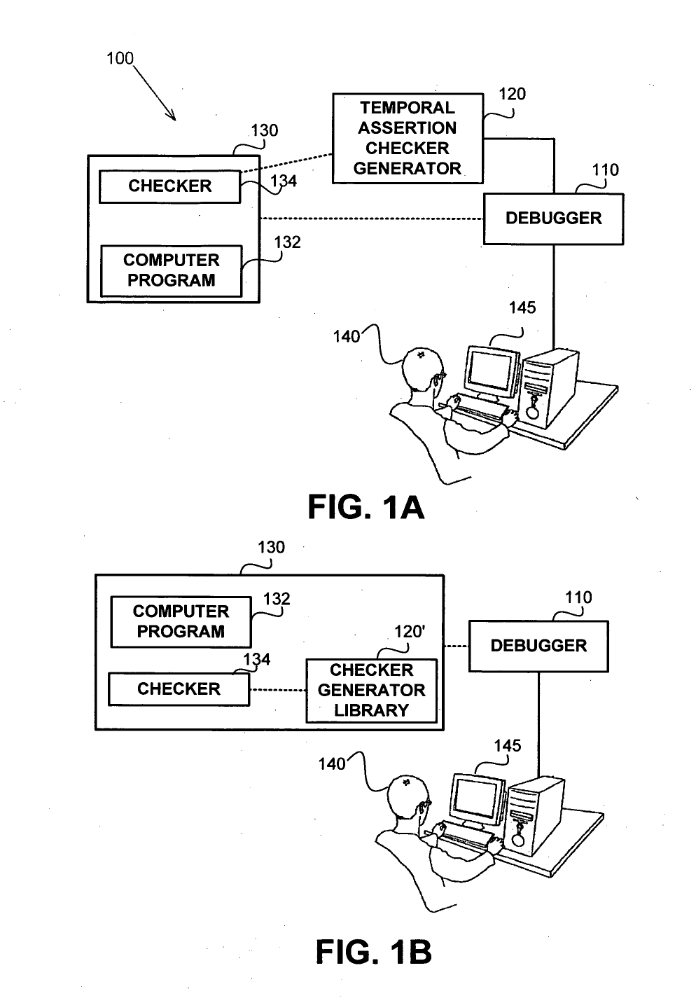

Referring now to FIG. 1A showing a computerized environment in which the disclosed subject matter is used, in accordance with some exemplary embodiments of the subject matter. A computerized environment 100 may comprise a debugger 110. The debugger 110 may be capable of loading an executable 130 to memory, executing the executable 130 in a debugging session, and enabling reviewing of the state of the execution at various times. In some exemplary embodiments, the debugger 110 may dynamically attach itself to an already loaded executable 130 that may have commenced execution.

In some exemplary embodiments, the user 140, such as a developer, a verification staff member, or the like, may utilize a Man-Machine Interface (MMI) 145, such as a terminal, to interact with the debugger 110, to review the state of the executable 130, to provide temporal assertions to be checked, or the like.

In some exemplary embodiments, a temporal assertion may be a statement in temporal logic defining a temporal relationship between variables and/or predicates of the Computer Program (CP) 132. The temporal relationship may be defined using temporal predicates such as next, eventually, until, globally, or the like. The temporal relationship may be examined in respect to some form of temporal semantic defining discrete and identifiable sets of states. A temporal semantic is the scheme that determines how and when time progresses. In some exemplary embodiments, a time progress semantic, controlled by a designated clock variable, also referred to hereinbelow as a clock semantic, may be enforced. The clock semantic may be a semantic in which the temporal events are defined by clock ticks. In response to a clock tick, a next temporal state commences. Additional temporal semantics may be applicable, such as user-defined temporal semantics which are based on a user-configurable update scheme. As is disclosed further hereinbelow, the user-configurable update scheme, such as for example a location semantic update scheme or a change semantic update scheme, may enable a user to define the occurrences in which the temporal assertion is evaluated.

In some exemplary embodiments, the CP 132 may be a software, firmware, or the like. The CP 132 may be an interactive program, a daemon program, an applet, a script, or the like. The CP 132 may be a sequential program or a parallel program, such as executing multiple threads, processes, or the like. The CP 132 may be a program designed for an embedded system, a network processor, a graphic processor, a mobile device, a mobile phone, or any other computerized platform. The CP 132 may be executed by a Virtual Machine (VM). In some exemplary embodiments, the CP 132 may be programmed using a general-purpose programming language. A “general-purpose programming language”, for the purpose of the present disclosure, is a any programming language that is not specifically designed for the introduction of temporal assertions to the CP 132. The general-purpose programming language may be C, C++, C#, Java, assembler language specifically designed for a predetermined processor, or the like. It will be noted that, as is disclosed hereinbelow, the CP 132 may be annotated for the purpose of introducing temporal assertions. However, such annotation is added-upon a program that is programmed using a general-purpose programming language.

In some exemplary embodiments, a temporal assertion checker generator 120 may generate a checker 134 based on the temporal assertion. In some exemplary embodiments, the temporal assertion checker generator 120 may be operately coupled to the debugger 110.

The temporal assertion checker generator 120 may be an internal or external module utilized by the debugger 110. In some exemplary embodiments, the debugger 110 may be operatively coupled to the generator 120 in a hard-coded manner. The debugger 110 may provide the temporal assertion to the temporal assertion checker generator 120, such as for example in response to a command from a user during an interactive debugging session. The generator 120 may generate the checker 134. The generator 120 may further compile the checker 134, link the checker 134 with the CP 132 into the executable 130, or couple the checker 134 with the CP 132 in a similar manner, and perform additional similar operations.

In some exemplary embodiments, the checker 134 is a Finite State Machine (FSM) associated with the temporal assertion. It will be noted that other embodiments may not utilize an FSM. However, for the clarity of disclosure and without limiting the scope of the disclosed subject matter, the checker 134 is assumed to define and maintain an FSM. The checker 134 may have an interface for updating the state of the FSM (e.g., receiving values of current state), and an interface for indicating that the temporal assertion is violated. The interface may be a predetermined protocol, a private protocol, an Application Programming Interface (API), or the like. In some exemplary embodiments, a predetermined function may be deemed as an interface to update the checker 134, a predetermined function may be deemed as an interface for returning an indicative value (e.g. true Boolean value) indicating whether the checker 134 determined that the temporal assertion is violated. In some exemplary embodiments, a single function may be operative to update the checker 134 and return the indicative value. The checker 134 may be a computer program product, such as loadable by the debugger 110 onto a computerized platform. The checker 134 may be generated after the executable 130 is loaded by the debugger 110 and dynamically loaded onto the executable 130. The checker 134 may be generated before loading of the executable 130, linked to the CP 132 and loaded together in the executable 130.

In some exemplary embodiments, the executable 130 may comprise the CP 132 and the checker 134. The executable 130 may be a computer program product configurable to execute the CP 132. In some exemplary embodiments, the checker 134 may monitor the execution of the CP 132, either passively or actively. For example, passively monitoring may comprise receiving updates of the values at each temporal state, whereas actively monitoring may comprise the checker 134 actively obtaining values at each temporal state. In some exemplary embodiments, the debugger 110 may utilize the interface of the checker 134 at predetermined occurrences, in accordance with the temporal semantics, to update the FSM and to determine whether the temporal assertion is violated.

Referring now to FIG. 1B showing an alternative computerized environment. The executable 130 comprises a checker generator library 120′ which is operative, once invoked, to generate the checker 134. The checker generator library 120′ is an embodiment of a temporal assertion checker generator 120. In some exemplary embodiments, the CP 132 and the checker generator library 120′ may be linked together and loaded by the debugger 110.

In some exemplary embodiments, the checker generator library 120′ may be dynamically introduced to the executable 130, such as using a debugger command such as GDB™'s load command. In response to commands from the user 140, such as defining the temporal assertion, the checker generator library 120′ may be invoked by the debugger 110 to generate the checker 134 and to dynamically link the checker 134 to the executable 130.

In some exemplary embodiments, the debugger 110 may be a general-purpose debugger, that is not specifically configured to support temporal assertions. The general-purpose debugger may not be specifically configured to interact with the checker generator library 120′.

The debugger 110 may be extended to support temporal assertions using a built-in extension feature of the debugger 110. The built-in extension feature may be, for example, GDB™'s load command, or a similar command, which loads an additional program into the memory space of an existing process and thus enabling to dynamically extend to debugged program with additional functionalities. As another example, the built-in extension feature of the debugger 110 may be a feature enabling applying a debugger script, enabling defining a debugger batch command, a command to dynamically invoke a function, a method or a similar code element, such as using GDB™'s call command. Additional and/or alternative built-in extension may be utilized.

Using a built-in extension feature, the debugger 110 may be configured to cause the desired interaction with the checker generator library 120′ based on an input command from the user 140, such as by invoking a function of the checker generator library 120′. In some exemplary embodiments, to provide for a user-friendly interface, the debugger 110 may be loaded with a script defining a batch command.

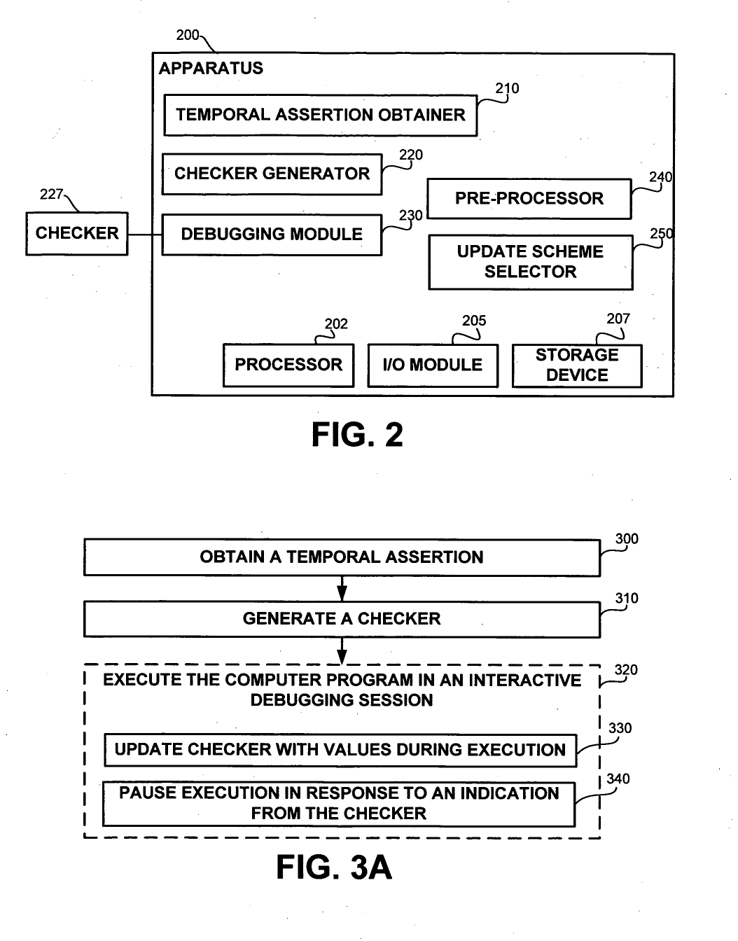

Referring now to FIG. 2 showing a block diagram of an apparatus, in accordance with some exemplary embodiments of the disclosed subject matter. An apparatus 200 may be configured to assist and/or hold an interactive debugging sessions of a CP, in accordance with the disclosed subject matter.

In some exemplary embodiments, a temporal assertion obtainer 210 may be configured to obtain a temporal assertion. The temporal assertion may be associated with variables of the CP. The temporal assertion may be obtained from a user, such as 140 of FIG. 1A, from the source code of the CP, or the like. In some exemplary embodiments, the user may provide the temporal assertion to the apparatus, such as for example during an interactive debugging session. In some exemplary embodiments, the user may annotate the source code of the CP with annotations indicative of the temporal assertion. In some exemplary embodiments, the temporal assertion may be obtained during an interactive debugging session. In some exemplary embodiments, a designated command, such as “BreakOnProperty” command may be issued during the interactive debugging session. The argument of the command may be the temporal assertion.

In some exemplary embodiments, a checker generator 220, such as 120 of FIG. 1A, may be operative to generate a checker 227, such as 134 of FIG. 1A, based on the obtained temporal assertion. The checker 227 may be configured to provide input and output using a predetermined interface. The interface may use a function. In some exemplary embodiments, the function may indicate that in the temporal semantic a new point in time has been reached. The function may update the checker 227 with the current values for the checker 227 to monitor. The checker 227 may indicate that the temporal assertion is violated such as for example by providing a predetermined return value to the function. For the clarity of the disclosure, and without limiting the scope of the disclosed subject matter, the interface is disclosed as a function “update” operable to receive current values for the variables observable by the temporal assertion being checked by the checker 227 and having a return value that is evaluated to “true” in case the temporal assertion is violated.

It will further be noted that in some exemplary embodiments, the checker 227 may alternatively perform active monitoring. In some exemplary embodiments, the checker 227 may actively observe values of the CP at predetermined occurrences defined by the temporal semantic, actively utilize the interface to the apparatus 200 to obtain the values at the predetermined occurrences (i.e., actively “pull” the data instead of passively receiving “pushed” data), or the like.

In some exemplary embodiments, the checker generator 220 may be a library module, such as a checker generator library 120′ of FIG. 1B. The library module may be configured to be linked with the CP. Functions of the library module may be invoked to generate the checker on-the-fly.

In some exemplary embodiments, the library module may be invoked using a function, such as “prepareForDebug”. The “prepareForDebug” function may be configured to generate an FSM based checker 227, compile the checker 227 into a dynamic loadable form, such as a Dynamic Linked Library (DLL), and load the DLL to memory and optionally initialize the checker 227 (e.g., using an init function).

In some exemplary embodiments, a debugging module 230 may be configured to execute the CP in a debugging session. The debugging module 230 may enable for an interactive debugging session, such as that the user may interact with the debugging module 230 and review values of variables. It will be noted that a variable may be a global variable, a local variable, a memory address allocated for the use of the CP during execution, or the like. During the interactive debugging session the user may input commands for the debugging module, such as “step over”, “step into”, “continue”, “set breakpoint”, “set watchpoint”, “evaluate” a statement, or the like.

In some exemplary embodiments, the debugging module 230 utilizes (or, alternatively, is) a general-purpose debugger, such as Microsoft® Visual Studio, GNU GDB™, or the like. In some exemplary embodiments, the general-purpose debugger may be extended using a built-in extension feature of the general-purpose debugger. In some exemplary embodiments, the debugging module 230 itself may be a debugger configured in accordance with the disclosed subject matter. The disclosed subject matter, therefore, discloses utilization of either specifically configured debuggers or general-purpose debuggers with conjunction with temporal assertions.

The debugging module 230 may be operative to load into memory, such as storage device 207, and execute an executable, such as 130 of FIG. 1A. In some exemplary embodiments, the debugging module 230 may be operative to invoke the library module to generate the checker 227 and dynamically link to the generated checker 227. In some exemplary embodiments, the generated checker 227 may be dynamically linked to the executable, and therefore the debugging module 230 may be able to interact with the checker 227.

In some exemplary embodiments, the debugging module 230 may be operative to execute the CP and to update the checker 227 with values of variables observable by the checker 227 during execution of the CP. In some exemplary embodiments, the debugging module 230 may be responsive to indications from the checker 227 of a violation of the temporal assertion. In response to the indication, the debugging module 230 may pause execution of the CP and enable a user to review the state of the CP. In some exemplary embodiments, the execution may be paused, and an interactive command line may be displayed for the user to input commands to the debugging module 230.

In some exemplary embodiments, the debugging module 230 may be operative to set stop-points for the debugging session. A stop-point, such as a breakpoint or a watchpoint, may be a definition of occurrences in which the execution of the CP should be paused while continuing the interactive debugging session. The stop-point may be conditioned, such that when the occurrence occurs, the condition is evaluated and in response to the condition being held, the execution may be paused. In some exemplary embodiments, in response to obtaining a temporal assertion by the temporal assertion obtainer 210, one or more stop-points may be set.

In some exemplary embodiments, the command “BreakOnProperty” and/or “WatchOnProperty” may be configured to invoke the checker generator 220 (e.g., by using the “PrepareForDebug” command), set stop-points in accordance with an update scheme.

The stop-point may utilize the interface to the checker 227 to update the checker 227 and to cause the debugging module 230 to pause execution in response to an indication from the checker 227.

In some exemplary embodiments, a breakpoint may be set to hold a location semantics update scheme. A location semantics update scheme is a semantic in which the checker 227 is updated once the CP reaches one or more predefined locations. A breakpoint may be set at each of the predefined locations. The breakpoint may be conditioned. In some exemplary embodiments, the condition may be update(var1, var2, . . . , varn), such that when evaluated, the checker 227 is updated to a new temporal state with current values of var1, var2, varn and returns an indication whether the temporal assertion is violated. In response to such an indication, the condition is held and the debugging module 230 may pause the execution. In some exemplary embodiments, “BreakOnProperty” command may be accompanied with one or more locations in the CP in which the breakpoints are set. In some exemplary embodiments, “BreakOnProperty” command may be invoked without such locations and current location of the CP may be induced as the location.

In some exemplary embodiments, a watchpoint may be set to hold a change semantics update scheme. A change semantics update scheme is a semantic in which the checker 227 is updated every time a variable is accessed. In some exemplary embodiments, update is performed in response to a change in the value and not by mere access. In some exemplary embodiments, the update is performed every time the variable's value is changed, whether directly by using the variable's name (e.g., a=0;) or indirectly, such as by accessing the memory address (e.g., *(p+2)=0;). In some exemplary embodiments, a watchpoint may be set to monitor access of variables. In some exemplary embodiments, in case the temporal assertion observes variables var1, var2, . . . , varn, watchpoints may be defined for each of the variables. In some exemplary embodiments, the user may be able to define a different list of one or more variables to be watched. In some exemplary embodiments, “WatchOnProperty” command may be accompanied with the list of variables. The command may invoke setting of one or more watchpoints, depending on the variables to be watched (either set manually, or defined inherently by the temporal assertion). The watchpoints may be conditioned. In some exemplary embodiments, the condition may be update(var1, var2, . . . , varn).

In one exemplary embodiment, a temporal assertion such as “always(request =>f(ack Before request))” may be used and evaluated using a change semantics update scheme. The assertion states that in case a request is issued then, sometime in the future (i.e., any following state), an acknowledge signal must be raised prior to an additional request being issued. Two watchpoints may be defined for the two variables request and ack. The watchpoints may be responsive to an access to the variables (even if the value remains unchanged), so as to avoid not detecting that two requests were issued one state after the other (and thus the value request=TRUE was unchanged). The watchpoint on ack may also be responsive to a mere access so as to avoid undetecting that two acknowledges are issued at consecutive states in response to two consecutive requests.

In some exemplary embodiments, the change semantics may prohibit the use of the “next” temporal operator, such as using a temporal logic excluding the “next” temporal operator, such as Lamport's Temporal Logic of Actions (TLA). As with every change of a single variable, the update semantics are invoked, what the user may consider as a “next state” may take a few temporal states to achieve. For example, the code: a=0; b=0; c=0; may be considered, when executed, as three temporal states (a=0, b=?, c=?), (a=0, b=0, c=?), (a=0, b=0, c=0). In some exemplary embodiments, in order to reduce confusion by the user, the user may not be allowed to assert conditions to be held within specific number of temporal states from an event (e.g., next operator requires a condition to be held in exactly one state), but rather may be allowed to assert conditions are held “sometime in the future” (e.g., eventually operator, f(uture) operator, or the like).

In some exemplary embodiments, instead of using a watchpoint, which monitors access and update to memory locations, instrumentation of the CP may be performed to catch direct accesses to the variable.

In some exemplary embodiments, a temporal semantic may be a clock scheme in which a clock tick indicates a new temporal state. A simulated clock may be maintained such as by updating a clock variable. In some exemplary embodiments, a clock update scheme may be implemented by using a conditional breakpoint on the code which updates the clock. In some exemplary embodiments, a clock update scheme may be implemented by using a conditional watchpoint on the value of the clock variable which is operative to be evaluated in response to a modification in the clock variable.

In some exemplary embodiments, a pre-processor 240 may be configured to instrument the CP with code operable to utilize the interface of the checker 227. In some exemplary embodiments, the pre-processor 240 may pre-process the CP prior to execution thereof. In some exemplary embodiments, the pre-processor 240 may pre-process the CP and instrument the CP with the code prior to compilation of the CP. In some exemplary embodiments, the pre-processor 240 may be configured to instrument code in predetermined places in the source code of the CP, such as based on annotations in the source code.

In some exemplary embodiments, the annotation may be utilized in order to enable setting stop-points in accordance with the disclosed subject matter when utilizing a debugger that does not support watchpoints and/or breakpoints that are conditioned on the value of a function (such as update).

Referring to location semantics, the annotation of the CP may include an annotation defining the temporal assertion, such as a definition in a header file stating: properly “theProperty” {a}=>{b[*1 . . . 3];c}. This temporal assertion asserts that after “a” is held “b” has to hold between 1 to 3 temporal states and then “c” has to hold. The pre-processor 240 may invoke the checker generator 220 to generate the checker 227 based on the defined temporal assertion. The annotation may further include an annotation in lines for which a breakpoint is to be defined, such as by stating: break “theProperty”. In case that the property named “theProperty” is defined (e.g., by an including the header file defining it), the pre-processor 240 may replace the break command with a command updating the checker 227 and assigning its indicative value to a flag variable. For example, the code may be instrumented with the following code:

flagVar=update_checker_{—}227(var1,var2, . . . ,varn);

where update_checker_227 is configured to update the specific checker generated for the temporal property “theProperty” with the values observable by the temporal property. The return value of the update function, which may be indicative of a violation of the temporal assertion, is assigned to a flag variable. A conditional breakpoint may be set in the instrumented line. The breakpoint may be conditioned on the value of the flag variable instead of being conditioned on the value of a function, which may not be supported in some debuggers. In some exemplary embodiments, the pre-processor 240 may set the breakpoints, such as by providing a command to the debugging module 230 to set the breakpoints. In some exemplary embodiments, the commands may be provided in a debugger script readable by the debugger used by the debugging module 230.

Referring now change semantics, the annotation of the CP may include an annotation defining the temporal assertion, such as disclosed above. The pre-processor 240 may process this annotation as disclosed above. The annotation may further comprise an annotation indicating that a watch is to be set, such as the annotation: watch “theProperty”. The pre-processor 240 may define a handler operative to be invoked in response to an update/access to a variable of the CP. The handler may be, for example:

void watchpointHandler( ) {

int flagVar = update_checker_227(var1, var2,...,varn);

}

The pre-processor 240 may create a watchpoint, as is known in the art of debuggers, that is operative in response to an access/update of one or more variables (e.g., variables mentioned in the property, variables defined in the annotation explicitly, or the like). As an example, the pre-processor 240 may set a software or hardware assisted exception operative to invoke the handler in response to an access/update of one or more variables. In some exemplary embodiments, the pre-processor 240 may set a breakpoint, conditioned on the value of flag variable, placed in the statement after the flag variable's value is set in the handler. In some exemplary embodiments, a debugger script may provide a command setting the breakpoint and loaded to the debugger upon execution thereof.

In some exemplary embodiments, an update scheme selector 250 may be operative to select an update scheme. For example, a user, such as 140 of FIG. 1A, may select the update scheme and provide the selection to the update scheme selector 250. In some exemplary embodiments, the selection may be performed by utilizing a different command, such as BreakOnPropoerty or WatchOnProperty.

The storage device 207 may be a Random Access Memory (RAM), a hard disk, a Flash drive, a memory chip, or the like. The storage device 207 may retain the CP, the checker 227, or similar computer program products. The storage device 207 may be used to load the CP to memory for its execution, such as by allocating a process for executing the CP or the like.

In some exemplary embodiments of the disclosed subject matter, the apparatus 200 may comprise an Input/Output (I/O) module 205. The I/O module 205 may be utilized to provide an output to and receive input from a user, such as 140 of FIG. 1.

In some exemplary embodiments, the apparatus 200 may comprise a processor 202. The processor 202 may be a Central Processing Unit (CPU), a microprocessor, an electronic circuit, an Integrated Circuit (IC) or the like. The processor 202 may be utilized to perform computations required by the apparatus 200 or any of it subcomponents.

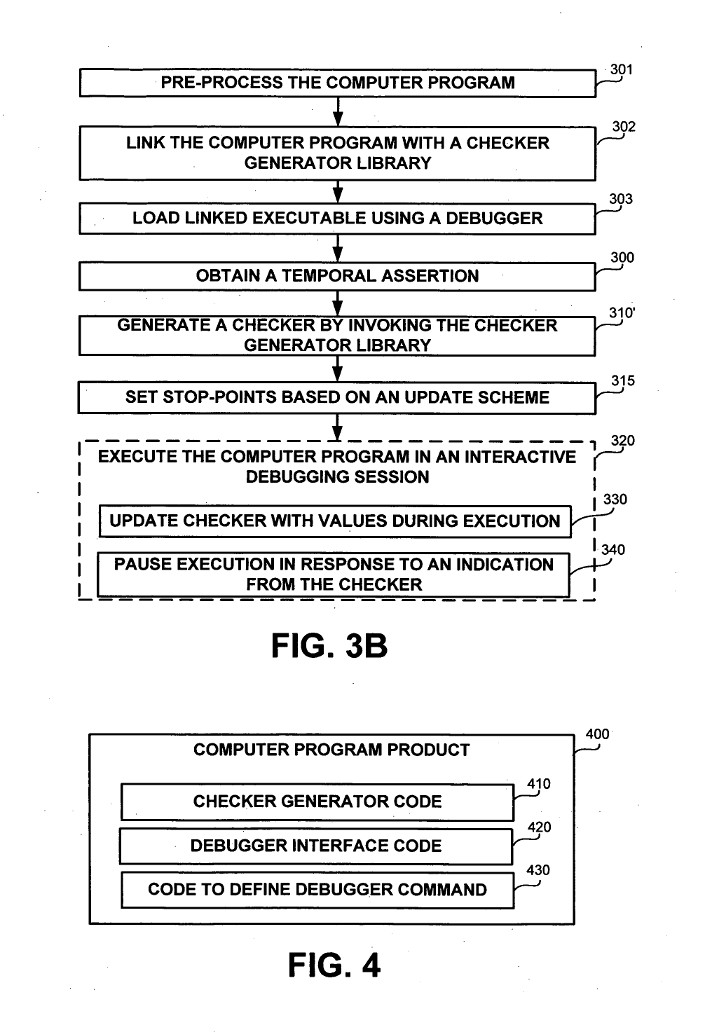

Referring now to FIG. 3A showing a flowchart diagram of a method in accordance with some exemplary embodiments of the disclosed subject matter.

In step 300, a temporal assertion may be obtained. The temporal assertion, such as defined by a temporal property to be held, may be obtained by a temporal assertion obtainer, such as 210 of FIG. 2. In some exemplary embodiments, the temporal assertion may be obtained from the source code of the CP, from a command from a user, such as a command line of debugger, or the like.

In step 310, a checker may be generated based upon the temporal assertion. The checker, such as 227 of FIG. 2, may be generated by a checker generator, such as 220 of FIG. 2.

In step 320, the CP may be executed in an interactive debugging session. The CP may be executed by a debugging module, such as 230 of FIG. 2. The execution may be performed using a debugger.

During execution of the CP, in step 330, the checker may be updated with values of variables that are observable by the temporal assertion. The update may be performed based on an update scheme. The update may be performed by evaluating a condition associated with a stop-point, as is disclosed hereinabove.

In step 340, execution of the CP may be paused in response to an indication of a violation of the temporal assertion. The indication may be provided by the checker. In some exemplary embodiments, the execution may be paused while the interactive debugging session is continued. The user may provide the debugging module 230 or a debugger utilized by the debugging module 230 with commands such as to review state of the CP, continue execution of the CP, or the like. In some exemplary embodiments, upon continuing execution of the CP, the execution may be paused again in response to additional indications from the checker.

Referring now to FIG. 3B showing a flowchart diagram of a variation on the method shown in FIG. 3A, in accordance with some exemplary embodiments of the disclosed subject matter.

In step 301, the CP may be pre-processed, such as by a pre-processing module 240 of FIG. 2. Annotations in the CP may be identified and replaced with code in accordance with the disclosed subject matter.

In step 302, the CP may be linked with a checker generator library, such as 120′ of FIG. 1B.

In step 303, the linked executable may be loaded to the memory of a computer using a debugger, using a debugging module, such as 230 of FIG. 2, or the like.

In step 310′, the checker may be generated by invoking a command defined by the checker generator library. The checker may be generated, compiled, and dynamically linked to the linked executable. The invocation may be in response to a command by a user. The command may invoke evaluation of a function defined by the checker generator library. The command may be an ordinary debugger command, such as call, or may be a user-defined command, that is defined using a debugger script loaded to the debugger or a similar built-in extension feature.

In step 315, stop-points may be defined by the debugger. The stop-points may be defined based on an update scheme, such as location or change semantics update schemes. The stop-points may be configured to perform step 330 and to enable pausing execution as is performed in step 340. In some exemplary embodiments, the stop-points are defined by a command given to the debugger. In some exemplary embodiments, the command may be the user-defined command, defined by a debugger script, and also operative to generate the checker in step 310′.

It will be noted that FIG. 3B may be performed using a general-purpose debugger, without performing modifications to the debugger itself. Thus, the disclosed subject matter teaches enhancement of the capabilities of the general-purpose debugger without hard-coded modifications to the debugger, but rather only by using built-in extension features of the general-purpose debugger.

Referring now to FIG. 4 showing a block diagram of a computer program product, in accordance with some exemplary embodiments of the disclosed subject matter. A computer program product 400, such as embodied on a computer-readable medium, may be configured to extend functionality of a debugger.

In some exemplary embodiments, a checker generator code 410 may be operative, upon execution, to generate a checker, such as 227 of FIG. 2, based on a temporal assertion. The checker generator code 410 may be loaded to memory together with the CP, such as by linking the two computer program products to a single executable and loading them to memory by the debugger

In some exemplary embodiments, a debugger interface code 420 may be operative, upon execution, to invoke the checker generator code 410 so as to generate a checker. The debugger interface code 420 may be configured to set stop-points in the debugger at predetermined occurrences, defined by an update scheme. The stop-points may be configured to update the generated checker and may be conditioned upon an indication from the generated checker. The stop-points may be defined in accordance to arguments provided to the debugger interface code 410, such as locations in the CP, variables of the CP, or the like. The debugger interface code 410 may define the update scheme, such as by using a different command for each type of update scheme, by using the same command with different arguments, or the like.

In some exemplary embodiments, a code to define debugger command 420 may be configured to define the debugger interface code 420 as a command in the debugger. In some exemplary embodiments, the debugger may be extendable by applying a debugger script. The debugger script may define commands such as WatchOnProperty, BreakOnProperty, or the like.

The different portions of the computer program product 400 may be defined using different programming languages. For example, the checker generator code 410 may be implemented in C, C++, C#, Java, or the like, whereas the debugger interface code 420 may be implemented using one or more debugger-specific commands, and the code to define debugger command 420 may be implemented in a debugger-specific scripting language.

The flowchart and block diagrams in the Figures illustrate the architecture, functionality, and operation of possible implementations of systems, methods and computer program products according to various embodiments of the disclosed subject matter. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module”, “system” and similar terms. Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosed subject matter has been presented for purposes of illustration and description, but is not intended to be exhaustive or limited to the subject matter in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

1-21. (canceled)

22. A computer-implemented method for debugging a program, the method performed by a computerized device, wherein the program is a computer program defined by a general-purpose programming language, the method comprising:
obtaining a temporal assertion, wherein the temporal assertion defines a temporal relationship, using temporal operators, between variables or predicates defined by the program;
generating a checker based on the temporal assertion, wherein the checker is a program product operative to monitor values of the variables and the predicates and provide an indication upon violation of the temporal assertion, said generating further comprises determining a monitoring schedule for invoking the checker according to a temporal semantic;
executing the program in an interactive debugging session, wherein during execution of the program the checker monitors the program at predetermined occurrences defined by the monitoring schedule; and
wherein in response to the indication from the checker, pausing the execution of the program while continuing the interactive debugging session.

23. The computer-implemented method of claim 22, wherein said obtaining is performed during the interactive debugging session.

24. The computer-implemented method of claim 22, wherein said executing comprises utilizing a general-purpose debugger; and wherein said generating the checker is performed during said executing, using a built-in extension feature of the general-purpose debugger.

25. The computer-implemented method of claim 24, further comprising applying a predetermined debugger script to the general-purpose debugger, wherein the predetermined debugger script defines a debugger command operative to invoke said generating and to set one or more stop-points associated with the checker.

26. The computer-implemented method of claim 22, further comprising, based on the temporal semantic, setting one or more stop-points for the interactive debugging session, wherein the stop-points are selected from the group consisting of breakpoints and watchpoints.

27. The computer-implemented method of claim 26, wherein the stop-point is a conditional stop-point having a condition, wherein the condition is responsive to the indication by the checker, wherein evaluating the condition is operative to update the checker, and wherein the conditional stop-points are operative to be evaluated during the execution of the program at predetermined occurrences associated with the temporal semantic.

28. The computer-implemented method of claim 26, further comprising:
pre-processing the program, wherein said pre-processing comprises instrumenting the program with code operative to update the checker in accordance with the temporal semantic and to assign an indicative value to a flag variable; and
wherein the stop-point is conditioned on the value of the flag variable.

29. The computer-implemented method of claim 22, wherein the temporal semantic is a user-configurable temporal semantic which is defined using a user-configurable update scheme.

30. The computer-implemented method of claim 29,
wherein the user-configurable update scheme is a location semantic update scheme;
said method further comprises:
obtaining indications to one or more program locations in the program associated with the user-configurable update scheme; and
setting a conditional breakpoint in each of the one or more program locations, wherein the conditional breakpoint is operative to initiate an update of the checker and to cause the execution to be paused in response to the indication from the checker.

31. The computer-implemented method of claim 29,
wherein the user-configurable update scheme is a change semantic update scheme;
said method further comprises:
determining one or more variables of the program;
setting a conditional watchpoint for each of the one or more variables, wherein the conditional watchpoint is operative to initiate an update of the checker and to cause the execution to be paused in response to the indication from the checker.

32. The computer-implemented method of claim 31, wherein the one or more variables are variables observable by the temporal assertion.

33. The computer-implemented method of claim 22, wherein the temporal semantic is defined by a simulated clock, wherein the checker is configured to monitor values of the program in response to a tick of the simulated clock.

34. A computerized apparatus for debugging a program, the computerized apparatus having a processor and a storage device, wherein the program is a computer program defined by a general-purpose programming language; the computerized apparatus comprising:
a temporal assertion obtainer operative to obtain a temporal assertion, wherein the temporal assertion defines a temporal relationship, using temporal operators, between values of variables or predicates defined by the program;
a checker generator operative to generate a checker based on the temporal assertion, wherein the checker is a program product operative to monitor values of the variables and the predicates and provide an indication upon violation of the temporal assertion, wherein said checker generator is further operative to determine a monitoring schedule for invoking the checker according to a temporal semantic;
a debugging module operative to execute the program in an interactive debugging session; the debugging module is operative to enable the checker to monitor the execution of the program at predetermined occurrences defined by the generated monitoring schedule; and
wherein said debugging module is responsive to the indication of the checker, wherein said debugging module is operative to pause the execution of the program while continuing the interactive debugging session in response to the indication.

35. The computerized apparatus of claim 34, wherein said debugging module is operative to set at least one stop-point for the interactive debugging session, wherein the stops-point is selected from the group consisting of a breakpoint and a watchpoint; and wherein the stop-point is responsive to the violation indication.

36. The computerized apparatus of claim 35, wherein the stop-points is a conditional stop-point having a condition, wherein said debugging module is operative to evaluate the condition at the predetermined occurrences defined by the temporal semantic; and wherein said debugging module is operative to provide the checker with values when evaluating the condition.

37. The computerized apparatus of claim 35 further comprising a pre-processor operative to instrument the program with code operative to initiate said checker at the predetermined occurrences and to assign the indication to a flag variable having a value; and wherein the stop-point is conditioned on the value of the flag variable.

38. A program product for debugging a program, the program product embedded on a non-transitory computer readable medium; wherein the program is defined by a general-purpose programming language; the program product comprising:
a first program instruction for generating a checker associated with a temporal assertion, wherein the temporal assertion defines a temporal relationship, using temporal operators, between values of variables or predicates defined by the program, wherein the checker is a computer program product operative to determine, in response to receiving updates of values of variables or the predicates defined by the computer program, whether the temporal assertion is violated, wherein the checker is operative to provide an indication upon violation of the temporal assertion, wherein said first program instruction is further operative for generating a monitoring schedule for invoking the checker, wherein the monitoring schedule is associated with a temporal semantic;
a second program instruction for interfacing with a general-purpose debugger, wherein the general-purpose debugger is configured to load the computer program and the first program instruction to a computer memory, wherein the second program instruction is operative to invoke the first program instruction, to cause the general purpose debugger to set stop-points at predetermined occurrences based on the monitoring schedule, wherein the stop-points are configured to update the checker generated by the first program instruction.

39. The program product of claim 38, further comprising a third program instruction for defining a debugger command to be received by the general-purpose debugger during an interactive debugging session, the debugger command operative to:
obtain a temporal assertion and the temporal semantic,
invoke the second program instruction, and
operate the general-purpose debugger to execute the computer program.

40. The computer-implemented method of claim 22, wherein the checker implements a Finite State Machine (FSM) associated with the temporal assertion, wherein the checker is operative to update a state of the FSM.

41. A computer-implemented method of claim 27, wherein the computer program, when executed, has a program memory space, wherein the checker is able to access the program memory space during monitoring, in order to determine values of the variables and the predicates of the temporal assertion.
